(19) United States
(12) Patent Application Publication
(10) Pub. No.: US 2017/0291518 A1
(43) Pub. Date: Oct. 12, 2017

(54) Capacitive Sensing Antenna Array

(71) Applicant: Magna Seating Inc., Aurora (CA)

(72) Inventor: Eric Kozlowski, Oakland Township, MI (US)

(21) Appl. No.: 15/479,308

(22) Filed: Apr. 5, 2017

Related U.S. Application Data
(60) Provisional application No. 62/318,850, filed on Apr. 6, 2016.

(51) Int. Cl. B60N 2/58; B60N 2/00; B60R 13/02; G01D 5/24

(52) U.S. Cl. CPC B60N 2/58; G01D 5/24; B60N 2/002; B60R 13/02

(57) ABSTRACT

A trim cover assembly for use on a seat assembly. The trim cover assembly comprises a trim cover layer of material having a topside and an opposite backside. A conductive coating is applied over one of the topside or backside of the tri cover. A capacitive sensing antenna array is positioned between the trim cover and the conductive coating wherein the conductive coating increase the signal strength of the capacitive sensing antenna array through the trim cover and thus the conductivity of the trim cover assembly.

### CROSS-REFERENCE TO RELATED APPLICATIONS

This application claims priority to and all the benefits of U.S. Provisional Application No. 62/318,850, filed on Apr. 6, 2016.

### BACKGROUND OF THE INVENTION

### 1. Field of the Invention

The present invention relates to a conductive trim cover coupled to a capacitive sensing antenna array.

### 2. Description of Related Art

Automotive vehicles include one or more seat assemblies having a seat cushion and a seat back for supporting a passenger or occupant above a vehicle floor. The seat assembly is commonly mounted to the vehicle floor by a riser assembly. The seat back is typically operatively coupled to the seat cushion by a recliner assembly for providing selective pivotal adjustment of the seat back relative to the seat cushion.

Systems for detecting, monitoring, and providing feedback for health and safety based on capacitive sensing are of increasing interest because heart rate and heart rate variability is an early predictor of driver drowsiness. Capacitive sensing in seats can have numerous applications, such as automotive driving, truck driving, air traffic controllers, pilots, or any other activity that requires an alert person in the seat. That is, the heart rate of the seat occupant can reflect the physical and mental state, and thus awareness, of the occupant.

Various heart rate sensing systems are currently available including an electrocardiogram (ECG), a ballistocardiogram (BCG), a phonocardiogram (PCG), a photoplethysmogram (PPF) and the like. Capacitive sensor antenna arrays are also currently known for sensing heart rate and heart rate variability without physical contact with the occupant. Examples of “non-contact” type capacitive sensor antenna arrays are disclosed in U.S. Pat. Nos. 3,740,567; 7,684,854; and 8,706,204.

However, materials in between the occupant and the capacitive sensor antenna array, such as clothing and the trim cover of the seat, degrade the signal strength of the capacitive sensors. For example, leather trim is commonly used in automotive seating applications for covering the foam pad of the seat assembly to provide occupant comfort, styling and aesthetics. The leather provides a soft surface, durability for the life of the surface, and a luxurious appearance and experience. However, leather also has the disadvantage of having very low conductivity.

Therefore, it is desirable to provide a conductive trim cover coupled with a capacitive sensor antenna array for increasing the signal strength of the system.

### SUMMARY OF THE INVENTION

A trim cover assembly is provided for use on a seat assembly. The trim cover assembly comprises a trim cover layer of material having a topside and an opposite backside. A conductive coating is applied over one of the topside or backside of the tri cover. A capacitive sensing antenna array is positioned between the trim cover and the conductive coating wherein the conductive coating increase the signal strength of the capacitive sensing antenna array through the trim cover and the conductivity of the trim cover assembly.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a fragmentary perspective view of a seat assembly for an automotive vehicle;

FIG. 2 is a plan view of a trim cover assembly according to one aspect of the invention;

FIG. 3 is a plan view of a trim cover assembly according to an alternative embodiment of the invention;

FIG. 4 is a plan view of a topside of a trim cover of the trim cover assembly;

FIG. 5 is a plan view of a topside of a perforated trim cover of the trim cover assembly; and

FIG. 6 is a magnified cross-sectional view of a conductive leather trim cover with embedded conductive particles according to an alternative embodiment.

### DETAILED DESCRIPTION OF THE EMBODIMENTS

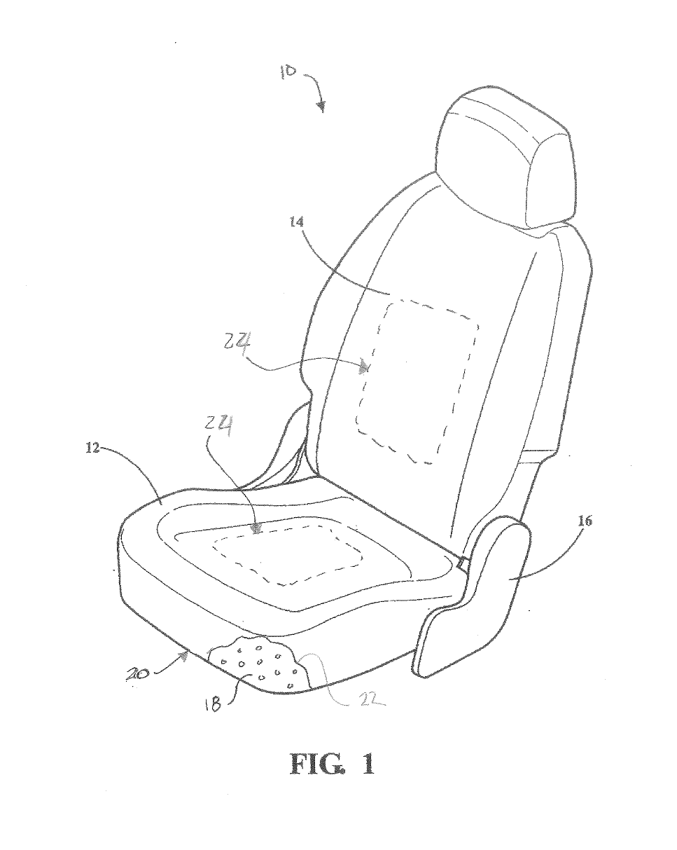

Referring to the Figures, wherein like numerals indicate like or corresponding parts throughout the several views, a seat assembly 10 for use in an automotive vehicle is generally shown in FIG. 1 and includes a generally horizontal seat cushion 12 and a generally upright seat back 14 for supporting a seat occupant within the vehicle, as is commonly known in the art. The seat back 14 is typically operatively coupled to the seat cushion 12 by a recliner assembly 16 for providing pivotal movement between an upright seating position and a plurality of reclined seating positions. Each of the seat cushion 12 and seat back 14 commonly include a molded resilient cellular foam pad 18 encased in a trim cover assembly 20, commonly of cloth, vinyl, or leather.

It is currently known to provide a capacitive sensing antenna array between the foam pad 18 and trim cover assembly 20 for sensing and providing data signals of the occupant's physiological conditions. Various examples of capacitive sensing antenna array are discussed in U.S. Pat. Nos. 7,684,854 and 8,706,204. However, the quality of the data signals degrades significantly as the capacitive sensing antenna array is positioned further away from the occupant. That is, clothing, objects, textiles and the leather trim cover can all reduce the signal strength to a point where the data signal is no longer usable or yields no information.

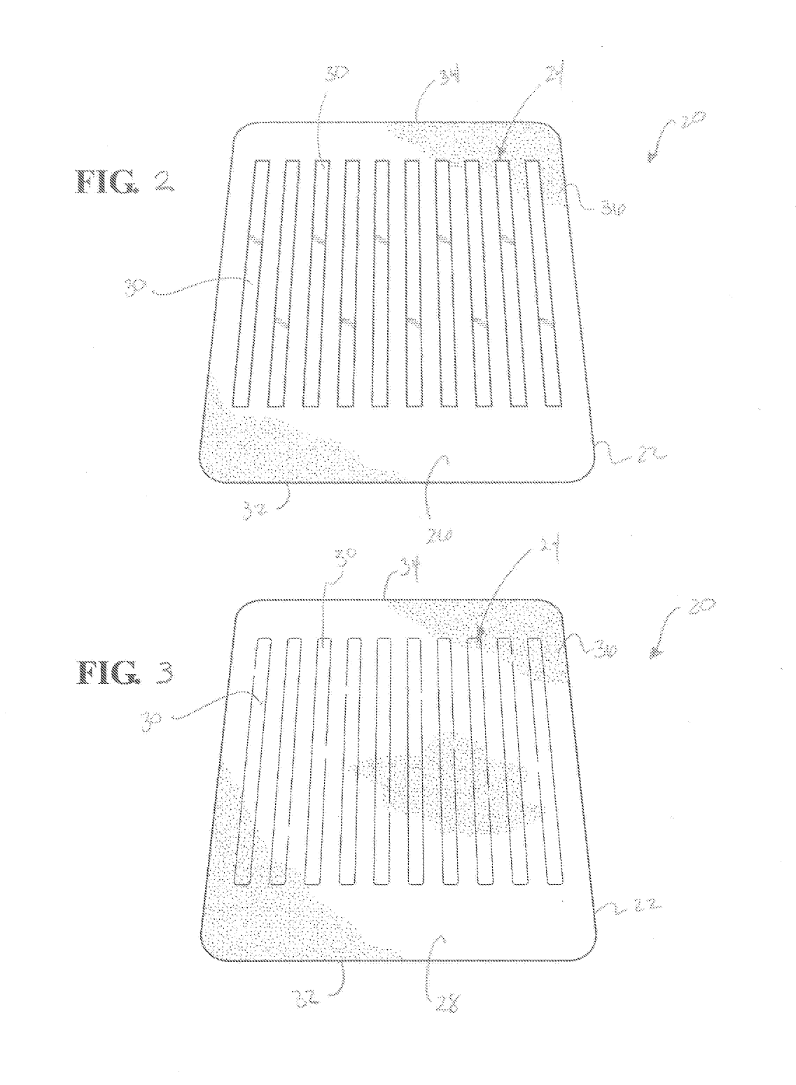

The present invention relates to a trim cover assembly comprising a conductive trim cover coupled with a capacitive sensor antenna array for increasing the conductivity of the trim cover assembly, and thus, the signal strength of the sensing system. More specifically, referring to FIG. 2, a first embodiment of the invention is shown wherein a trim cover assembly 20 includes a leather trim cover 22 having a capacitive sensing antenna array 24 positioned on a backside 26, or B surface, of the trim cover 22. In an alternative embodiment of the invention shown in FIG. 3, the capacitive sensing antenna array 24 is positioned on a topside 28, or A surface, of the trim cover 22. The backside 26 of the trim cover 22 is the surface of the trim cover 22 immediately adjacent the foam pad 18 and the topside 28 is opposite the backside 26 and defines the seating surface of the trim cover assembly 20. The capacitive sensing antenna array 24 may be positioned in various configurations and sizes on the backside 26 or topside 28 of the trim cover 22. In the embodiments shown in FIGS. 2 and 3, the capacitive sensing antenna array 24 is arranged as elongated, spaced apart and parallel strips of sensors 30 extending between a front portion 32 and rear portion 34 of the trim cover 22. The trim cover assembly 20 further includes a conductive coating 36 applied to the backside 26 (FIG. 2) or topside 28 (FIG. 3) of the trim cover 22 and over the capacitive sensing antenna array 24 to increase the conductivity of the trim cover assembly 20, and thereby increase the signal strength of the sensing system. In the preferred embodiment, the conductive coating 36 is comprised of graphite and/or aluminum particles.

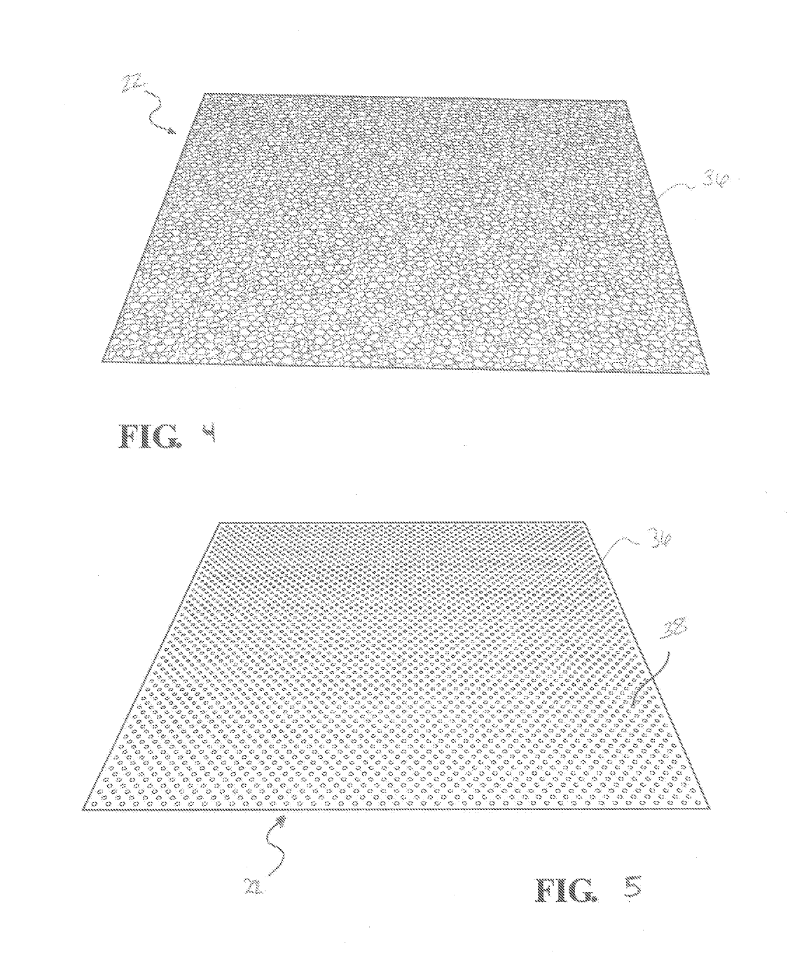

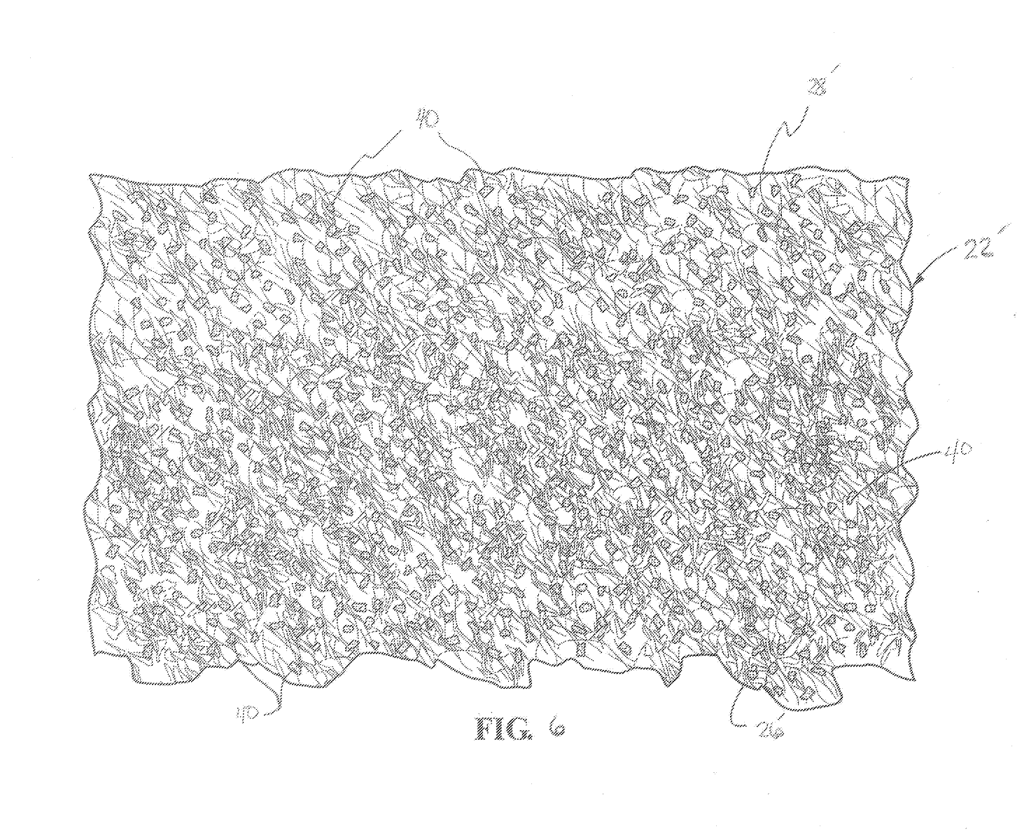

For example, referring to FIGS. 4 and 5, the conductive trim cover 22 with the conductive coating 36 is shown. The trim cover 22 is a sheet or skin layer of leather material. Typically, imperfections in a skin layer of leather are filled with a polymer spackle spread on the back surface of the leather, as is commonly known in the leather manufacturing process. In the present invention, the backside 26 or topside 28 of the leather skin is spackled with the conductive coating 36 to add a layer of conductive material to the trim cover 22. In the preferred embodiment, the conductive coating 36 is comprised of graphite and/or aluminum particles with a preferred particle size of 30 microns or less having an acrylic or urethane binder system to contain the conductive particles. It should be appreciated that the coating may also be comprised of other filler materials of high conductivity such as copper. Further, the skin of leather is often perforated with small holes or perforations 38 therethrough to allow air circulation through the skin layer. It is also possible to fill these perforations 38 in the skin of leather with the conductive coating 36, as shown in FIG. 5, and form a conductive pathway through the perforations 38 from the backside 26 to the topside 28 of the trim cover 22.

Referring to FIG. 6, an alternative embodiment of the trim cover 22′ is shown. The alternative trim cover 22′ relates to providing additives to the leather tanning process to enhance the conductive properties of the leather trim cover 22′. Referring to FIG. 6, a magnified cross-sectional view of a leather trim cover 22′ having a topside 28′ and a backside 26′ is shown magnified at approximately 60×. The leather trim cover 22′ shown includes randomly dispersed and embedded conductive particles 40 spread throughout the 3-dimensional weave of the leather and spread between the topside 28′ and the backside 26′. More specifically, the leather trim cover 22′ is embedded with conductive particles 40 consisting of aluminum, aluminum oxide, graphite, graphene, silver, copper, carbon nanotubes, or any other suitable conductive filler material to enhance the conductivity of the leather material. The process and formulation for saturating and dispersing the conductive particles 40 into the leather during the tanning process is fully described in Applicant's U.S. patent application Ser. No. 15/474,240, which is incorporated herein by reference.

The capacitive sensing antenna array 24 may be sandwiched between the conductive trim cover 22′ of FIG. 6 and the foam pad 18 and electrically coupled to the trim cover 22′ to similarly increase the conductivity of the trim cover assembly 20, and thereby increase the signal strength of the sensing system.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A trim cover assembly adapted for use on a seat assembly, said trim cover assembly comprising:
a trim cover layer of material having a topside and an opposite backside;
a conductive coating applied over one of said topside and said backside; and
a capacitive sensing antenna array positioned between said trim cover and said conductive coating wherein said conductive coating increases the signal strength of said capacitive sensing antenna array through the trim cover and the conductivity of said trim cover assembly.

2. The trim cover assembly as set forth in claim 1 wherein the conductive coating includes conductive particles selected from the group consisting of graphite, graphene, aluminum, aluminum oxide, silver, copper, or carbon nanotubes.

3. The trim cover assembly as set forth in claim 1 wherein the conductive coating includes graphite particles disposed in a urethane binder to increase the conductivity of said trim cover between said topside and said backside.

4. The trim cover assembly as set forth in claim 1 wherein said capacitive sensing antenna array includes a plurality of parallel and spaced apart capacitive sensors coupled between said trim cover and said conductive coating.

5. The trim cover assembly as set forth in claim 2 wherein said trim cover comprises a layer of leather material and said conductive coating covering one of said topside and backside of the layer of leather material to form a conductive trim cover.

6. The trim cover assembly as set forth in claim 5 wherein the layer of leather material includes a plurality of perforations extending therethrough between said topside and said backside.

7. The trim cover assembly as set forth in claim 6 wherein said plurality of perforations in said layer of leather material are filled with said conductive coating.

8. A trim cover assembly adapted for use on a seat assembly, said trim cover assembly comprising:
a trim cover having a topside and an opposite backside;
a capacitive sensing antenna array positioned adjacent one of said topside and said backside of said trim cover;
said trim cover comprising a layer of leather material having conductive particles embedded therein between said topside and said backside for increasing the signal strength of said capacitive sensing antenna array through said trim cover and the conductivity of the trim cover assembly.

9. The trim cover assembly as set forth in claim 8 wherein the conductive particles are selected from the group consisting of graphite, graphene, aluminum, aluminum oxide, silver, copper, or carbon nanotubes.

10. The trim cover assembly as set forth in claim 9 wherein said conductive particles include graphite embedded is said leather material and spaced apart between said topside and said backside.
